(19) United States
(12) Patent Application Publication
(10) Pub. No.: US 2011/0240722 A1
(43) Pub. Date: Oct. 6, 2011

(54) Food Item Placement and Containment System

(75) Inventor: Bonnie S. Stromme, Fort Collins, CO (US)

(73) Assignee: WRAP-N-MAT, INC., Loveland, CO (US)

(21) Appl. No.: 13/127,216

(22) PCT Filed: Nov. 3, 2008
(86) PCT No.: PCT/US08/82281

§ 371 Date: May 2, 2011

(51) Int. Cl. B65D 75/00; B31B 1/26

(52) U.S. Cl. 229/87.08; 493/243

(57) ABSTRACT

Methods and apparatus may permit the placement and containment of food items (3). A food containment capability and a food placement capability may be integrated into a single device. Converting between food containment and food placement may be accomplished in a single process. An integrated food containment and food placement device may be configured for reusability. One or more inside corners may be utilized on an integrated food placement and containment device to facilitate conversion from food placement to food containment functionality. An integrated food placement and containment device may utilize a layered structure.

### TECHNICAL FIELD

Generally, the inventive technology described herein relates to methods and apparatus for the placement and containment of food items. More specifically, the inventive technology may involve integrating both food item placement and food item containment in a single functionality. The inventive technology may be particularly suited for providing convenient transportation and consumption of various kinds of food items.

### BACKGROUND

Food items may represent a challenge to move around and consume. The characteristics of food, such as messiness, tendency to spoil, and the like may require specialized containers for transportation and specialized accoutrements for consumption. A variety of such containers may have been developed, including for example boxes, bags, wraps, and the like. Similarly, food accoutrements often used when consuming food items may include placemats, napkins, and the like.

When food items are to be stored and transported, however, such as when prepared at home for later consumption at work, or the like, having separate containers and additional accoutrements may pose an inconvenience. For example, having to carry each of a container and perhaps napkins or placemats may tend to reduce the convenience afforded by making the food item portable in the first place. Moreover, conventional containers and accoutrements often may be designed for disposal after a single use, as may be the case with various kinds of plastic or paper products. This perhaps may create waste products that need to be disposed of Additionally, conventional containers and accoutrements may not be conveniently shaped to fit particular food items, as may be the case for rigid boxes or various kinds of bags. Sheet materials perhaps may be unwieldy to bend, fold, seal, or the like, for example perhaps where the sheet may become bunched or gathered, perhaps increasing the bulk of the container.

Accordingly, the foregoing problems regarding conventional food item containers and accoutrements may represent a long-felt need for an effective solution to the same. While implementing elements may have been available, actual attempts to meet this need to the degree now accomplished may have been lacking to some degree. This may have been due to a failure of those having ordinary skill in the art to fully appreciate or understand the nature of the problems and challenges involved. As a result of this lack of understanding, attempts to meet these long-felt needs may have failed to effectively solve one or more of the problems or challenges here identified. These attempts may even have led away from the technical directions taken by the present inventive technology and may even result in the achievements of the present inventive technology being considered to some degree an unexpected result of the approach taken by some in the field.

### SUMMARY DISCLOSURE OF THE INVENTION

The inventive technology relates to methods and apparatus for placing and containing food items and may include one or more of the following features: techniques for integrating a food containment capability and a food placement capability into a single device; techniques for converting between a food containment capability and a food placement capability in a single process; techniques for reusing an integrated food containment and food placement device; techniques for utilizing one or more inside corners on an integrated food containment and food placement device; techniques for utilizing a layered structure of an integrated food containment and food placement device, and the like. Naturally, further objects of the inventive technology will become apparent from the description and drawings below.

### BRIEF DESCRIPTION OF THE DRAWINGS

FIG. 1 is a perspective view of a foldable food item containment pouch having four inside corners, each said corner having a double-cut configuration, in one embodiment.

FIG. 2 is a perspective view of a foldable food item containment pouch having two folded-over panels and four inside corners being intermediately converted into four outside corners, in one embodiment.

FIG. 3 is a perspective view of a foldable food item containment pouch having four folded-over panels and four outside corners, in one embodiment.

FIG. 4 is a perspective view of a layered structure of a foldable food item containment pouch, in one embodiment.

FIG. 5 is a perspective view of an inside corner having a wing, in one embodiment.

FIG. 6 is a perspective view of an inside corner having a flap, in one embodiment.

FIG. 7 is a perspective view of an inside corner having a clip, in one embodiment.

FIG. 8 is a perspective view of a inside corner having a compound double-cut configuration, in one embodiment.

FIG. 9 is a side view of a volume adjustable fold, in one embodiment.

### MODES FOR CARRYING OUT THE INVENTION

The present inventive technology includes a variety of aspects, which may be combined in different ways. The following descriptions are provided to list elements and describe some of the embodiments of the present inventive technology. These elements are listed with initial embodiments, however it should be understood that they may be combined in any manner and in any number to create additional embodiments. The variously described examples and preferred embodiments should not be construed to limit the present inventive technology to only the explicitly described systems, techniques, and applications. Further, this description should be understood to support and encompass descriptions and claims of all the various embodiments, systems, techniques, methods, devices, and applications with any number of the disclosed elements, with each element alone, and also with any and all various permutations and combinations of all elements in this or any subsequent application.

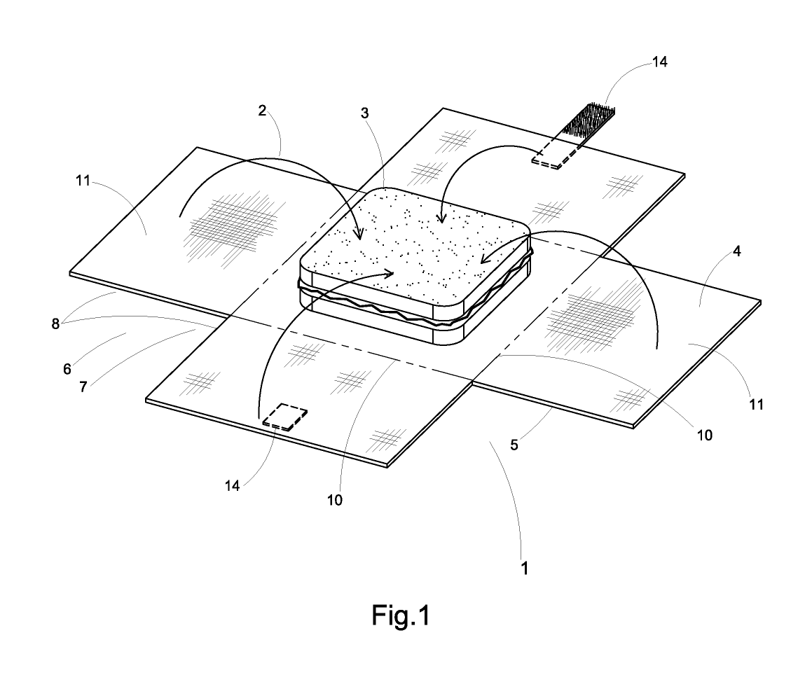

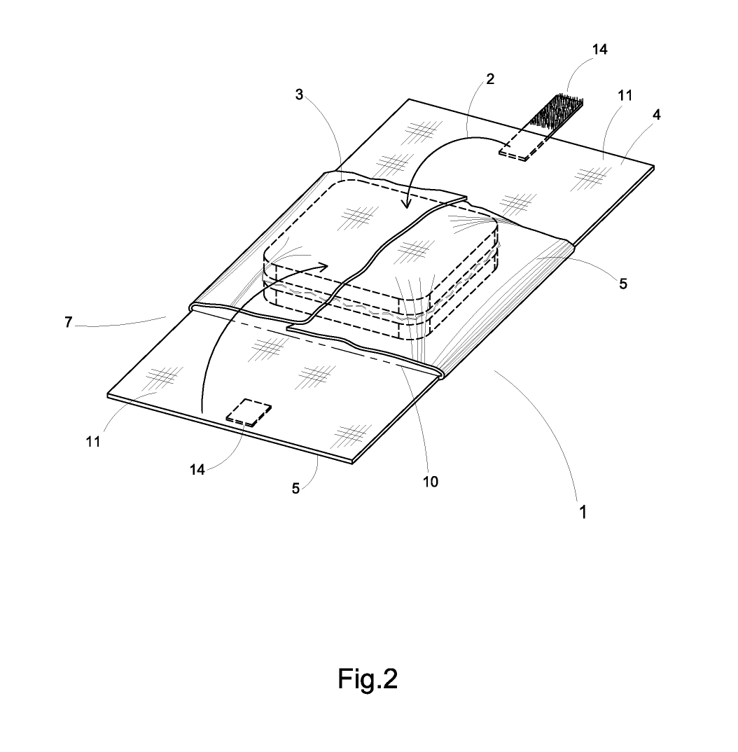

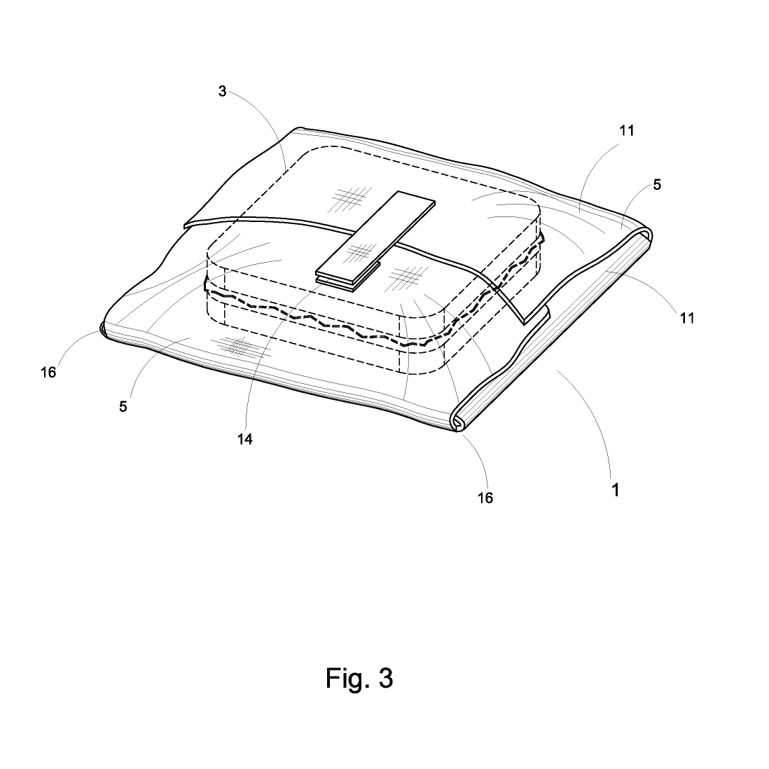

Now referring primarily to FIGS. 1-3, embodiments of the inventive technology may utilize a foldable food item containment pouch (1) having a direction of fold (2). The direction of fold (2) may be the direction in which the material comprising the pouch may be folded over to create a pouch for a food item (3). In this manner, the pouch may have an interior food placement surface (4) and an exterior food protection surface (5), the former being the inside of the folded pouch and the latter being the outside of the folded pouch. Accordingly, the direction of fold (2) may define the interior food placement surface (4) and the exterior food protection surface (5) of the pouch.

A foldable food item containment pouch (1) in various embodiments may be part of an integrated food containment and placement apparatus. For example, when the pouch is in an unfolded state, it may provide a relatively flat, wide surface on which a food item (3) may be placed. In this capacity, the unfolded pouch may function like a placemat. Moreover, when the pouch is in a folded state, it may serve to contain a food item (3) within the pouch. In this capacity, the folded pouch may function like a container. The pouch may be seen therefore to integrate food containment and placement functions in a single apparatus.

The interior food placement surface (4) may be selected in various embodiments to have properties conducive to placing a food item (3). Any suitable property for which such a surface is capable of retaining may be selected. For example, such properties may include providing a stain resistant surface, providing a leak-proof surface, providing a non-absorbent surface, providing a no-stick surface, and the like. Similarly, the exterior food protection surface (5) may be selected in various embodiments to have properties conducive to protecting a food item (3). Any suitable property for which such a surface is capable of retaining may be selected. For example such properties may include providing an airtight surface, providing an insulating material for said surface, providing a decorative surface, and the like. Naturally, a food item (3), such as a sandwich or the like, may be placed on the interior food placement surface (4), and embodiments may involve folding over the pouch material around the food item (3) to create the pouch. When the pouch is unfolded, the interior food placement surface (4) may serve as a placemat for the food item (3). When the pouch is folded, the interior food placement surface (4) may serve to contain the food item (3).

A foldable food item containment pouch (1) in various embodiments may include at least one closure (14). The closure (14) may serve to secure the pouch in a folded position after the pouch has been suitably folded. Of course, any suitable closure capable of so securing the pouch may be utilized, including for example mechanically securing with mechanical fasteners, magnetically securing with magnetic fasteners, adhesively securing with adhesive fasteners, securing with Velcro, or the like. Moreover, in various embodiments the pouch may be provided with more than one closure (1), for example to make the pouch more secure in its folded configuration. For example, each folding part of the pouch may be provided with its own closure (14), as for example to permit securing any or all fold panels (11) of the pouch. In some embodiments, each fold panel (11) of a pouch may be provided with its own closure (14). The pouch also may be provided with any suitable accessories that may be attached to or formed as part of the structure of the pouch, for example such as pockets to hold condiments, ice packs, silverware, napkins, clips or straps so that the pouch may be attached to other items, plastic windows that allow a name card or other card to be inserted, and the like.

In some embodiments, a foldable food item containment pouch (1) may have an inside corner (6). An inside corner (6) may be a point along the perimeter of the unfolded pouch wherein two edges of the pouch intersect such that the empty space within the corner forms an angle of less than 180 degrees. The empty space within the corner also may be seen to form a material-free fold zone (7), in as much as no pouch material may be present in this space to hinder, bulk, or otherwise interfere with folding of the pouch.

Moreover, an inside corner (6) may be understood to have a double-cut configuration (8). For example, the inside corner (6) may be formed by making two cuts along the perimeter of the unfolded pouch, each cut corresponding to one of the edges that intersect to form the inside corner (6). A double-cut configuration (8) in various embodiments also may include a compound double-cut configuration (9), for example as shown in one embodiment in FIG. 8. In a compound double-cut configuration (9), one or more of the cuts forming the double-cut configuration (8) may itself be cut off at some angle. For example, in the compound double cut shown in FIG. 8, the inside corner may be seen to be formed by two edges intersecting at 90 degrees, wherein one of the two edges itself is further cut at an angle of 45 degrees.

Embodiments of the foldable food item containment pouch (1) may have more than one inside corner (6). For example, the unfolded pouch may have at least a first inside corner (6), at least a second inside corner (6), at least a third inside corner (6), and at least a fourth inside corner (6). Moreover, each inside corner (6) may be part of a polygonal shape in which a foldable food item containment pouch (1) is established. For example, an unfolded pouch with four inside corners (6) in some embodiments may be established as rectangular in shape, or perhaps even square, wherein each point of the rectangle is replaced with an inside corner (6), for example as by double-cutting each outside corner of the rectangle to create an inside corner (6).

Additionally, inside corners (6) of course may be of any angle up to but not including 180 degrees, including greater than or lesser than 90 degrees. For example, embodiments may include an unfolded pouch having at least one inside corner (6) at a 90 degree angle, or perhaps even each inside corner at an angle of 90 degrees.

In various embodiments, a foldable food item containment pouch (1) may have one or more fold axes (10), about which a part or parts of the unfolded pouch may be folded. A fold axis (10) may be an actual structural component of the pouch itself, for example perhaps a weak zone in the pouch material susceptible to folding, created as by stitching, joining two different pouch materials together to form a joint, or the like. Alternatively, a fold axis (10) simply may be an imaginary line on the pouch about which parts of the pouch are folded.

Moreover, a fold axis (10) may be aligned to lie in-line with at least one cut of an inside corner (6) having a double-cut configuration (8). FIGS. 1-3, for example, may illustrate several examples of fold axes (10) and cuts of inside corners (6) wherein each fold axis (10) lies along at least one imaginary line, the imaginary line also coinciding with at least one cut of a inside corner (6) having a double-cut configuration (8). Of course, embodiments may involve a foldable food item containment pouch (1) with one, two, three, four, or more fold axes (10). Where an unfolded pouch has multiple fold axes (10), embodiments may involve any suitable configuration for aligning one or more fold axes (10) in-line with one or more cuts of any number of inside corners (6) having at least a double-cut configuration (8). For example, embodiments may include each cut of at least one inside corner lying in line with at least one fold axis (10), or perhaps even each cut of each inside corner (6) lying in line with at least one fold axis (10). The flexibility in aligning fold axes (10) in-line with the cuts of inside corners (6) having a double-cut configuration (8) may promote flexibility in folding a pouch along the boundaries of inside corners (6), as shown for example in FIGS. 1-3. In turn, this may permit folding of the pouch to gain the advantage of material-free zones (7), for example to make folding the pouch easier and reduce the bulk of the folded pouch.

A foldable food item containment pouch (1) also may include one or more fold panels (11). A fold panel (11) simply may be a part of the unfolded pouch capable of folding over, for example perhaps along a fold axis (10). A pouch may be configured to have any suitable number of fold panels (11), for example at least one, at least two, at least three, at least four, or perhaps even more than four. Selection of the number of fold panels, for example, may be made to accommodate different sizes or shapes of a food item (3) to be contained. In some embodiments, a fold panel (11) may be situated between two inside corners (6). The edges of the fold panel (11) in such configurations may include the cuts of the adjacent inside corners (6). The boundaries of a fold panel (11) further may include a fold axis (10).

Fold panels (11) also may be dimensioned in any suitable configuration to effect a desired fold. For example, embodiments may include uniformly dimensioning multiple fold panels (11) to have the same dimensions. For example, FIGS. 1-3 may illustrate a pouch configured with four fold panels (11) having the same dimensions, each fold panel (11) situated between two inside corners (6), and each fold panel (11) bounded by a fold axis (10). However, fold panels (11) may be variably dimensioned to effect different fold configurations. For example, embodiments may involve dimensioning one fold panel (11) as a lengthened food item cover panel and dimensioning another fold panel (11) as a shortened food item access panel. In this manner, the lengthened food item cover panel may serve to substantially cover a food item (3) when folded over, while the shortened food item access panel may simply provide an access panel which may be opened or closed to access the food item (3) without the need to unfold the pouch.

In various embodiments, an inside corner (6) may be convertible into a folded outside corner (16). A folded outside corner (16) may be a point along the perimeter of the folded pouch wherein two edges of the pouch intersect such that the empty space outside of the corner forms an angle of greater than 180 degrees. Converting an inside corner (6) to a folded outside corner (16) may be accomplished by suitably folding over various parts of a foldable food item containment pouch (1). For example, each edge of an inside corner (6) may correspond to parts of a foldable food item containment pouch (1). Folding over these parts of the pouch may move the edges, such that when the parts have been folded and the edges have been moved, the edges are repositioned so that they no longer form the inside corner (6). In this manner, the inside corner (6) may be seen to be replaced by a folded outside corner (16). More specifically, in some embodiments an inside corner (6) may have a double-cut configuration (8), wherein each cut corresponds to the edge of a fold panel (11). When the fold panel (11) is folded over, the cuts may be moved to a position within the folded pouch, and the inside corner (6) may be replaced with a folded outside corner (16). In the foregoing manner, a convertible inside corner (6) may be seen as being able to be configured as either an inside corner (6) or a folded outside corner (16), depending on the state of fold of the pouch.

In various embodiments, a folded outside corner (16) may be a food item barrier. In particular, the folds of the folded outside corner (16) may form a food item barrier impeding a tendency of foodstuffs in the pouch from escaping through the folded edges of the pouch. Moreover, because folded outside corners (16) may be formed in part from inside corners (6) having material-free fold zones (7), the folded outside corner (16) may have reduced bulk by virtue of being formed without pouch material that otherwise would be present in the material-free fold zone (7). In this manner, the folded outside corner (16) may be seen to have a reduced bulk mass proportional to the material-free fold zone (7). In addition, various embodiments may involve forming folded outside corners (16), in which two or more folds overlap to form the outside corner. In this situation, at least one of the overlapping folds may serve to support in place at least one other of the overlapping folds, thereby perhaps adding stability to the folded outside corner (16) tending to keep its shape. In this manner, at least one fold of a folded outside corner (16) may be seen to be a support emplacement for at least one other fold of a folded outside corner (16).

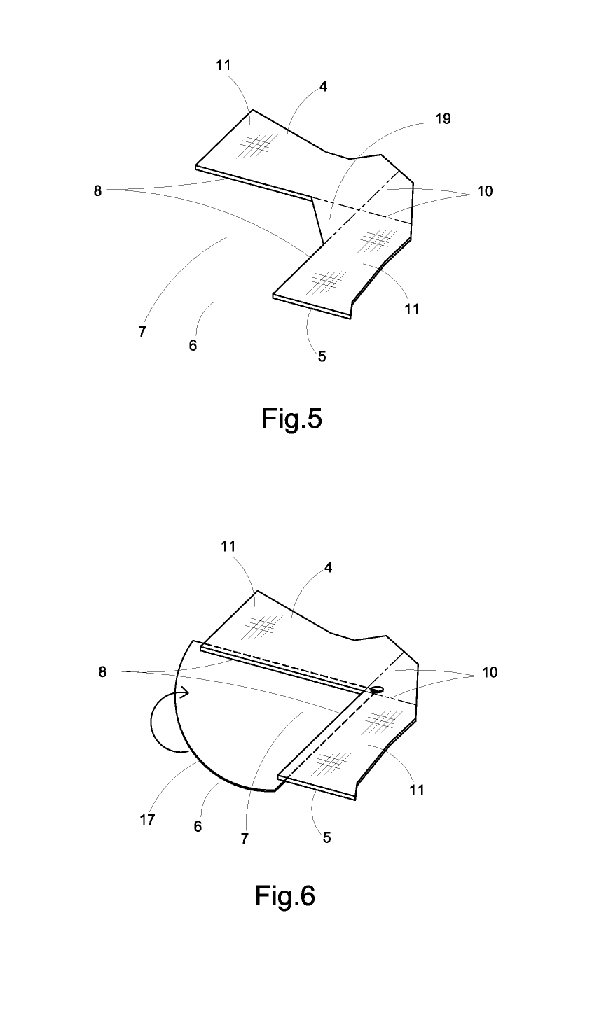

Embodiments may include a corner seal situated at an inside corner (6). The corner seal may act to seal a folded outside corner (16), for example so as to prevent the passage of foodstuffs from the interior of the folded pouch to the exterior, or to prevent passage of contaminants from the exterior of the folded pouch to the interior. In some embodiments, a corner seal may be a wing (19), such as shown in one embodiment in FIG. 5. A wing (19) may project from the body of a foldable food item containment pouch (1) into a portion of a material-free fold zone (7) of an inside corner (6), such that folding the inside corner (6) into a folded outside corner (16) correspondingly folds the wing (19) to form a corner seal. The structure of the wing (19) may be formed in any suitable manner. For example, embodiments may include forming the wing (19) as part of the pouch itself, as perhaps where the wing may be part of a pattern from which the pouch is cut out. Similarly, the wing (19) may be separately attached to the pouch, perhaps involving separately attaching a separate piece of material to the pouch at an inside corner (6) to form the wing (19). The wing (19) also may be made from material having any suitable characteristic, such as elasticity, stain-resistance, leak-proofing, non-absorbency, non-sticking, air tightness, insulation, decoration, or any other suitable characteristic, or perhaps may be even simply the same material as the pouch itself. The edge of the wing (19) may have any suitable configuration, including for example a straight edge, a curved edge, an irregular edge, or the like. Selection of an appropriate configuration may be made to promote effectiveness of the seal, facilitate folding of the pouch, or the like. The wing (19) also may be joined to the pouch in any suitable manner. For example, in some embodiments the wing (19) may be joined to each edge of an inside corner (6) having a double-cut configuration at varying distances from the inside corner (6), such as about 0.5 inches from the inside corner (6), about 1.0 inch from the inside corner (6), about 1.5 inches from the inside corner (6), about 2.0 inches from the inside corner (6), about 2.5 inches from the inside corner (6), about three inches from the inside corner (6), and so forth. The wing (19) also may project into a material-free fold zone (7) to cover any suitable area of the zone, including for example about 5% of the area of the zone, about 10% of the area of the zone, about 15% of the area of the zone, about 20% of the area of the zone, about 25% of the area of the zone, about 30% of the area of the zone, about 35% of the area of the zone, about 40% of the area of the zone, about 45% of the area of the zone, and about 50% of the area of the zone. The wing (19) also may be placed at any suitable number of inside corners (6) of an unfolded pouch, including for example perhaps at one inside corner (6), at two inside corners (6), or even at all inside corners (6). Of course, the foregoing examples related to various characteristics of the wing (19) are merely illustrative, and should not be construed to limit embodiments of the pouch consistent with the principles discussed herein.

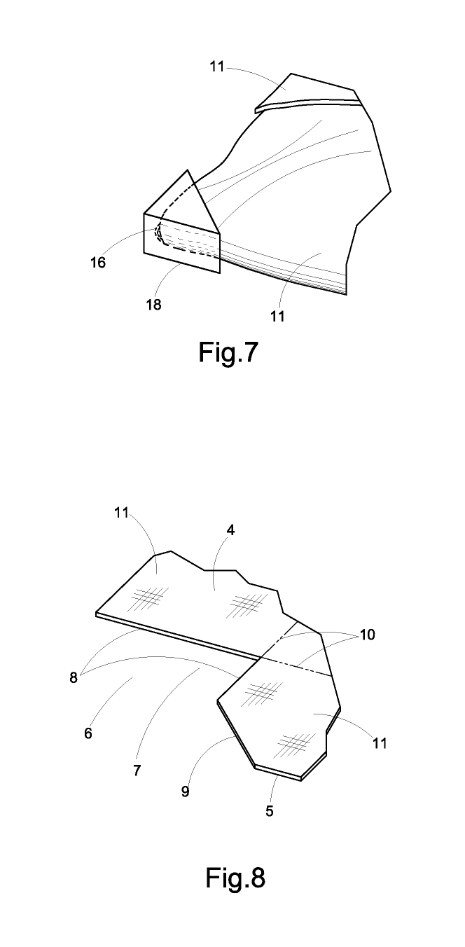

In some embodiments, a corner seal may be independently manipulable, such that any folded outside corner (16) may be sealed in a step independent from the steps required to form the folded outside corner (16). In some embodiments, an independently manipulable corner seal may be a clip (18) that can be positioned to cover a folded outside corner (16), such as shown in one embodiment in FIG. 7. Sealing the corner in such embodiments may involve simply clipping the corner. An independently manipulable corner seal in various embodiments also may include a flap (17) attached to the pouch, as shown in one embodiment in FIG. 6. The flap (17) may be configured not to impede a folding motion of any cut of a double-cut configuration of an inside corner, for example perhaps by overlapping the flap (17) to cover the material-free fold zone (7) of an inside corner (6) without being attached to the folding edges of that inside corner (6), or perhaps by positioning the flap (17) retracted from the material-free fold zone (7) and moving the flap to overlap the material-free fold zone (7) when needed. After the pouch is folded and a folded outside corner (16) is formed, the flap (17) may be moved into position to seal off the corner, as perhaps by folding over the flap (17) to cover the folded outside corner (16), and perhaps secured into place with a suitable closure (14).

Of course, the food item barriers, corner seals, wings, flaps, and the like discussed herein in various embodiments may contribute to forming the pouch of a foldable food item containment pouch (1). For example, these components may tend to create pouch-like structures when folded, such as bottoms, sidewalls, and similar enclosing structures. Functionally, a folded pouch having these components may serve some or all of the functions of a conventional pouch, such as securely holding a food item placed therein, preventing foodstuffs from leaking out of the pouch, preventing contaminants from entering the pouch, and the like.

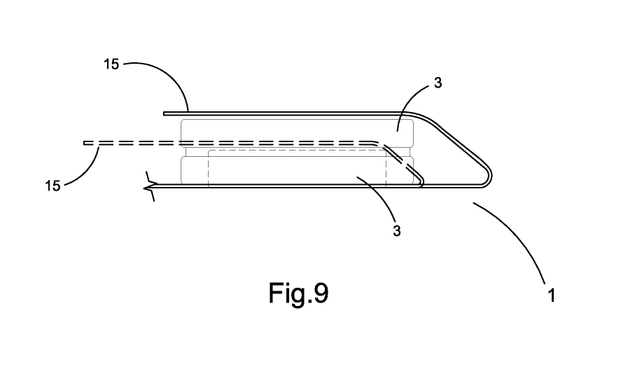

Now with reference primarily to FIG. 9, a foldable food item containment pouch (1) in various embodiments also may have at least one volume adjustable fold (15). The capability to adjust the volume of a fold may involve dimensioning the unfolded pouch so that at least one part of the pouch may be capable of folding to varying extents or degrees. In this manner, the interior volume capacity of the pouch may be adjusted, as to accommodate food items (3) of various sizes. For example, a volume adjustable fold (15) in some embodiments may be a fold panel (11), wherein the fold panel (11) is situated between adjacent inside corners (6), and the material-free fold zones (7) provide a degree of play in the folding action of the fold panel (11), such that the extent of fold can be adjusted. Moreover, a volume adjustable fold in various embodiments may be a food item (3) conformable fold, wherein the degree of fold may be controlled to conform to a food item (3) placed within the pouch. Conforming the degree of fold in this manner, for example, may aid in snugly securing the food item (3) within the pouch. A food item (3) conformable fold may be understood to include simply one volume adjustable fold (15), or perhaps multiple volume adjustable folds (15). For example, embodiments may include one food item conformable fold larger than one other fold of a pouch, two food item conformable folds larger than two other folds of a pouch, and so forth. In this manner, embodiments may involve adjusting at least one fold to a greater degree than at least one other fold, adjusting at least two folds to a greater degree than at least two other folds, and so forth.

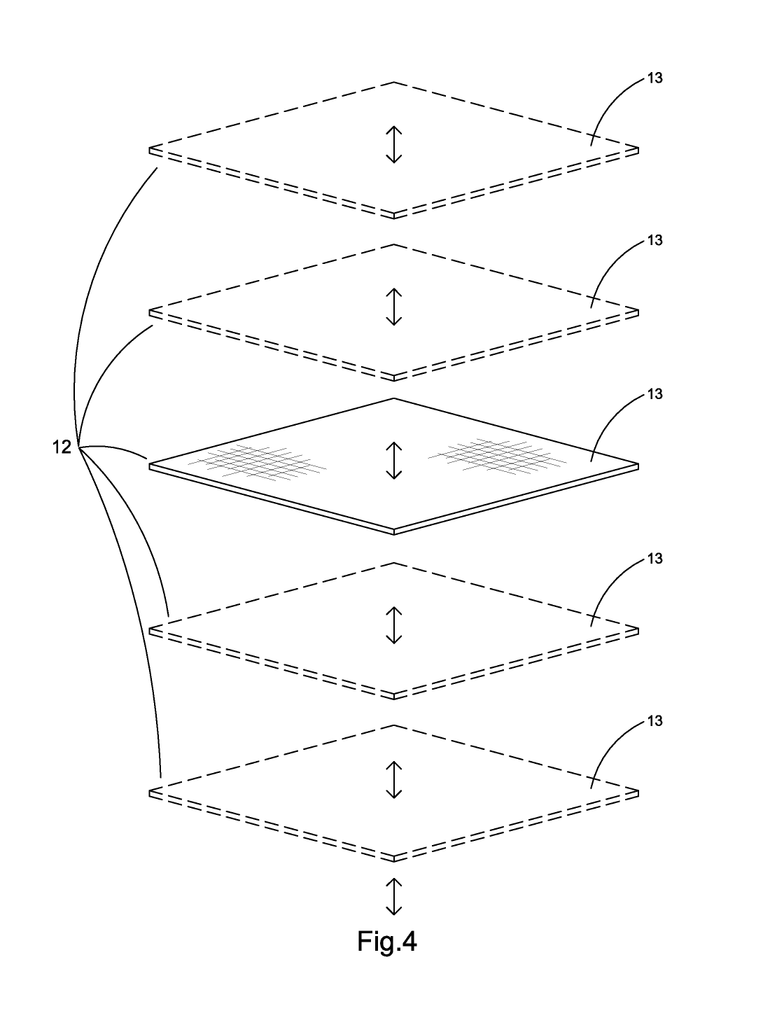

Now referring primarily to FIG. 4, a foldable food item containment pouch (1) may have a layered structure (12), wherein the structure of the pouch may be formed at least in part of one or more layers (13) of material. In some embodiments, each layer (13) in the structure may have a shape substantially in correspondence with the shape of the other layers (13) in the structure. The layers (13) may be aligned with one another in a stacked manner, and the structure may be formed by placing the layers (13) in substantially contiguous contact with one another. Each layer (13) may be attached to the adjoining layers (13) in any suitable manner, for example perhaps by laminating the layers (13) together, gluing the layers (13) together, stitching the layers together, and the like. Attachment may be made in a continuous manner, for example where the entire contiguous surfaces of the layers (13) may be joined, or along portions of the layers (13), for example by attaching the layers (13) along aligned peripheral edges thereof. Of course, fabricating a food placement mat convertible into a food storage container may involve shaping layers (13), aligning layers (13), stacking layers (13), attaching layers (13), and creating a layered structure (12) as described herein.

Each layer (13) may be made of any suitable material. Examples of suitable materials may include cloth, plastic, or other materials that are neither cloth nor plastic. For example, suitable cloth materials may include cotton, polyester, linen, blended cloths, or the like. Suitable plastics may include vinyl, vinyl coated fabric, LDPE, nylon, polypropylene, plastics having a thickness of about 3 mm, and the like. Suitable materials that are neither plastic nor cloth may include paper, rubber, and the like. The choice of material may be selected based on the use to which the foldable food item containment pouch (1) may be put. For example, embodiments may involve dimensioning a pouch to flex to a food item (3) utilizing a flexible food item dimensioned material, which may include materials having suitable flexibility to accommodate a food item (3) placed within the pouch while tending to rebound to the pouch's original configuration when the food item (3) is removed.

The layered structure (12) may be made of any number of layers (13) in any combination of materials as may be appropriate for the uses to which a foldable food item containment pouch (1) may be put. Selection of the specific number of layers (13) and the specific materials of which each layer (13) is made may be based on the decorative appearance of the pouch, preserving the freshness of a food item (3) to be contained, containing spills or other messiness of a food item (3) to be contained, and so forth. Examples may include at least one layer (13), at least two layers (13), at least three layers (13), or perhaps four or more layers (13), each layer (13) being made of any cloth, plastic, or other material as appropriate. For example, in some embodiments of a layered structure (12) having three contiguous layers (13), the three layers (13) may include two cloth layers (13) separate by one plastic layer (12), no layer (13) being made of plastic, no layer (13) being made of cloth, and at least one layer (13) being made of a material that is not plastic or cloth.

Now with reference primarily to FIGS. 1-3, various embodiments may involve converting a food placement mat into a food storage container. The process may involve replacing at least one inside corner (6) by forming a folded outside corner (16). For example, embodiments may involve folding over a first fold panel (11) along a first fold axis (10). An edge of the first fold panel (11) may correspond to at least one cut of an adjacent inside corner having at least a double-cut configuration (8). Folding over this edge of the first fold panel (11) may cause the edge to be moved from an inside corner position to an outside corner position. A second fold panel (11), adjacent to the inside corner and having an edge corresponding to the other cut of the double-cut configuration (8) of the inside corner (6), may be likewise folded over. As a result of folding over the first fold panel (11) and the second fold panel (11), the inside corner (6) may be replaced by a folded outside corner (16). This folded outside corner (16) may have at least some overlapping portions of left adjacent and right adjacent fold panels (11) which were folded over to form the folded outside corner (16). Moreover, the folded outside corner (16) may form an interior food placement surface (4) within the fold and an exterior food protection surface (5) outside of the fold.

Of course, any number of inside corners (6) may be replaced by folded outside corners (16) in the foregoing manner For example, the first fold panel (11) and second fold panel (11) each may have both a left edge and a right edge corresponding to cuts of left adjacent and right adjacent inside corners (6) having at least a double-cut configuration (8). Moreover, a foldable food item containment pouch (1) may have a third fold panel (11), a fourth fold panel (11), and indeed as many fold panels (11) as may be necessary or desirable. When the fold panels (11) are folded over in the manner described herein, the inside corners (6) adjacent to the fold panels (11) may be converted into and replaced by folded outside corners (16). A food placement mat accordingly may be converted into a food storage container having an interior food placement surface (4) within the folds of the pouch, and an exterior food protection surface (5) outside of the folds of the pouch.

Where fold panels (11) have edges corresponding to cuts of inside corners (6) having at least double-cut configurations (8), it may be seen that panels adjacent to one another across an inside corner (6) will have an orientation relative to one another equal to the angle of the inside corners (6). At a 90 degree inside corner, for example, a fold panel (11) on one side of the inside corner (6) will be oriented at an angle of 90 degrees relative to the fold panel (11) on the other side of the inside corner (6). If the inside corner (6) has an angle of greater than 90 degrees, then the two fold panels will be oriented relative to each other at that greater angle. Similarly, if the inside corner (6) has an angle of less than 90 degrees, then the two fold panels will be oriented relative to each other at an angle of less than 90 degrees. Naturally, the edges of fold panels (11) may correspond to cuts of inside corners (6) having a compound double-cut configuration (8).

Naturally, with respect to the foregoing, all examples discussed herein are merely illustrative, and should not be construed to limit embodiments of the inventive technology consistent with the principles discussed herein.

As can be easily understood from the foregoing, the basic concepts of the present inventive technology may be embodied in a variety of ways. It involves both food item placement and containment techniques as well as devices to accomplish the appropriate food item placement and containment. In this application, the food item placement and containment techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this patent application is intended to serve as a basic description. The reader should be aware that the specific discussion may not explicitly describe all embodiments possible; many alternatives are implicit. It also may not fully explain the generic nature of the inventive technology and may not explicitly show how each feature or element can actually be representative of a broader function or of a great variety of alternative or equivalent elements. Again, these are implicitly included in this disclosure. Where the inventive technology is described in device-oriented terminology, each element of the device implicitly performs a function. Apparatus claims may not only be included for the device described, but also method or process claims may be included to address the functions the inventive technology and each element performs. Neither the description nor the terminology is intended to limit the scope of the claims that will be included in any subsequent patent application.

It should also be understood that a variety of changes may be made without departing from the essence of the inventive technology. Such changes are also implicitly included in the description. They still fall within the scope of this inventive technology. A broad disclosure encompassing both the explicit embodiment(s) shown, the great variety of implicit alternative embodiments, and the broad methods or processes and the like are encompassed by this disclosure and may be relied upon when drafting the claims for any subsequent patent application. It should be understood that such language changes and broader or more detailed claiming may be accomplished at a later date (such as by any required deadline) or in the event the applicant subsequently seeks a patent filing based on this filing. With this understanding, the reader should be aware that this disclosure is to be understood to support any subsequently filed patent application that may seek examination of as broad a base of claims as deemed within the applicant's right and may be designed to yield a patent covering numerous aspects of the inventive technology both independently and as an overall system.

Further, each of the various elements of the inventive technology and claims may also be achieved in a variety of manners. Additionally, when used or implied, an element is to be understood as encompassing individual as well as plural structures that may or may not be physically connected. This disclosure should be understood to encompass each such variation, be it a variation of an embodiment of any apparatus embodiment, a method or process embodiment, or even merely a variation of any element of these. Particularly, it should be understood that as the disclosure relates to elements of the inventive technology, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this inventive technology is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “fold” should be understood to encompass disclosure of the act of “folding”—whether explicitly discussed or not—and, conversely, were there effectively disclosure of the act of “folding”, such a disclosure should be understood to encompass disclosure of a “fold” and even a “means for folding.” Such changes and alternative terms are to be understood to be explicitly included in the description.

Any patents, publications, or other references mentioned in this application for patent are hereby incorporated by reference. Any priority case(s) claimed by this application is hereby appended and hereby incorporated by reference. In addition, as to each term used it should be understood that unless its utilization in this application is inconsistent with a broadly supporting interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the following are hereby appended and hereby incorporated by reference, however, as to each of the above, to the extent that such information or statements incorporated by reference might be considered inconsistent with the patenting of this/these inventive technology such statements are expressly not to be considered as made by the applicant(s).

### I. U.S. Patent Documents

| DOCUMENT NO. & | PUB'N DATE | PATENTEE OR |
|---|---|---|
| KIND CODE (if known) | mm-dd-yyyy | APPLICANT NAME |
| 2,837,267 | 06-03-1958 | Potdevin et al. |
| 2,831,624 | 04-22-1958 | Lever |
| 2,686,004 | 08-10-1954 | Reiss |
| 2,594,394 | 04-29-1952 | Casselman et al. |
| 2,437,934 | 03-16-1948 | Brink |
| 2,306,335 | 12-22-1942 | Feigenbutz |
| 2,085,038 | 06-29-1937 | Perreton |
| 1,991,450 | 02-19-1935 | Doble |
| 1,881,890 | 10-11-1932 | Offenbacher |
| 1,385,831 | 07-26-1921 | Hulbert |
| 1,288,548 | 12-24-1918 | Finkenhagen |
| 923182 | 06-01-1909 | Joachim |
| 561762 | 06-09-1896 | Clarke |
| 526799 | 10-02-1894 | Barnard |
| 4,618,992 | 10-21-1986 | La Grotteria |
| 4,575,000 | 03-11-1986 | Grodon et al. |
| 4,557,385 | 12-10-1985 | Robinson |
| 4,524,870 | 06-25-1985 | Roccaforte et al. |
| 4,484,350 | 11-20-1984 | Gordon |
| 4,375,258 | 03-01-1983 | Crayne et al. |
| 4,292,332 | 09-29-1981 | McHam |
| 3,690,542 | 09-12-1972 | Jernstrom |
| 3,684,156 | 08-15-1972 | Fettinger et al. |
| 3,623,653 | 11-30-1971 | Work |
| 3,594,177 | 06-20-1971 | McGowan |
| 3,310,265 | 03-21-1967 | Mulloy |
| 3,099,593 | 06-30-1963 | Syracuse |
| 3,035,754 | 05-22-1962 | Meister |
| 4,754,914 | 07-05-1988 | Mischusen, III |
| 6,808,072 | 10-26-2004 | Snedeker et al. |
| 6,113,266 | 09-05-2000 | Skidmore |
| 5,964,534 | 10-12-1999 | Welles |
| 5,875,894 | 03-02-1999 | Stromme |
| 5,609,901 | 03-11-1997 | Geddes et al. |
| 5,585,027 | 12-17-1996 | Young |
| 5,564,223 | 10-15-1996 | Takita |
| 5,560,945 | 10-01-1996 | Geddes et al. |
| 5,507,579 | 04-16-1996 | Sorenson |
| 5,335,996 | 08-09-1994 | Cortopassi et al. |
| 5,328,265 | 07-12-1994 | Clooney |
| 5,279,456 | 01-18-1994 | Bernstein |
| 5,267,795 | 12-07-1993 | Bernstein et al. |
| 5,199,792 | 04-06-1993 | Roosa |
| 4,941,756 | 07-17-1990 | Price |
| 4,932,556 | 06-12-1990 | Hui et al. |
| 4,895,742 | 01-23-1990 | Schaub et al. |
| 4,806,397 | 02-21-1989 | Horwitz |
| D413723 | 09-14-1999 | Quansah |
| 4,618,992 | 10-20-1986 | LaGrotteria |
| 5,042,666 | 08-27-1991 | Dolenc |
| 5,205,479 | 04-27-1993 | Sorenson |
| 5,221,040 | 06-22-1993 | Sorenson |
| 5,332,147 | 06-26-1994 | Sorenson |

### II. Foreign Patent Documents

| Foreign Patent Document | | |
|---|---|---|
| Country Code, Number, Kind | PUB'N DATE | PATENTEE OR |
| Code (if known) | mm-dd-yyyy | APPLICANT NAME |
| EP 1350439 A2 | 10-08-2003 | A & F Trademark, Inc. |

Thus, the applicant(s) should be understood to have support to claim and make a statement of invention to at least: i) each of the food item placement and containment devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) each system, method, and element shown or described as now applied to any specific field or devices mentioned, x) methods and apparatuses substantially as described hereinbefore and with reference to any of the accompanying examples, xi) the various combinations and permutations of each of the elements disclosed, xii) each potentially dependent claim or concept as a dependency on each and every one of the independent claims or concepts presented, and xiii) all inventions described herein.

With regard to claims whether now or later presented for examination, it should be understood that for practical reasons and so as to avoid great expansion of the examination burden, the applicant may at any time present only initial claims or perhaps only initial claims with only initial dependencies. The office and any third persons interested in potential scope of this or subsequent applications should understand that broader claims may be presented at a later date in this case, in a case claiming the benefit of this case, or in any continuation in spite of any preliminary amendments, other amendments, claim language, or arguments presented, thus throughout the pendency of any case there is no intention to disclaim or surrender any potential subject matter. It should be understood that if or when broader claims are presented, such may require that any relevant prior art that may have been considered at any prior time may need to be re-visited since it is possible that to the extent any amendments, claim language, or arguments presented in this or any subsequent application are considered as made to avoid such prior art, such reasons may be eliminated by later presented claims or the like. Both the examiner and any person otherwise interested in existing or later potential coverage, or considering if there has at any time been any possibility of an indication of disclaimer or surrender of potential coverage, should be aware that no such surrender or disclaimer is ever intended or ever exists in this or any subsequent application. Limitations such as arose in Hakim v. Cannon Avent Group, PLC, 479 F.3d 1313 (Fed. Cir 2007), or the like are expressly not intended in this or any subsequent related matter. In addition, support should be understood to exist to the degree required under new matter laws—including but not limited to European Patent Convention Article 123(2) and United States Patent Law 35 USC 132 or other such laws—to permit the addition of any of the various dependencies or other elements presented under one independent claim or concept as dependencies or elements under any other independent claim or concept. In drafting any claims at any time whether in this application or in any subsequent application, it should also be understood that the applicant has intended to capture as full and broad a scope of coverage as legally available. To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Finally, any claims set forth at any time are hereby incorporated by reference as part of this description of the inventive technology, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

1. An integrated food containment and placement apparatus comprising:
a foldable food item containment pouch having a direction of fold, said direction of fold defining an interior food placement surface of said foldable food item containment pouch inside of said fold, and said direction of fold defining an exterior food protection surface of said foldable food item containment pouch outside of said fold;
at least a first inside corner of said foldable food item containment pouch, said at least first inside corner having an at least double-cut configuration along the perimeter of said foldable food item containment pouch, and said at least double-cut configuration forming a material-free fold zone of said foldable food item containment pouch;
at least a second inside corner of said foldable food item containment pouch, said at least second inside corner having an at least double-cut configuration along the perimeter of said foldable food item containment pouch, and said at least double-cut configuration forming a material-free fold zone of said foldable food item containment pouch;
at least a third inside corner of said foldable food item containment pouch, said at least third inside corner having an at least double-cut configuration along the perimeter of said foldable food item containment pouch, and said at least double-cut configuration forming a material-free fold zone of said foldable food item containment pouch;
at least a fourth inside corner of said foldable food item containment pouch, said at least fourth inside corner having an at least double-cut configuration along the perimeter of said foldable food item containment pouch, and said at least double-cut configuration forming a material-free fold zone of said foldable food item containment pouch;
wherein said foldable food item containment pouch comprises at least one volume adjustable fold.

2. (canceled)

3. An integrated food containment and placement apparatus as described in claim 1 wherein at least one said inside corner comprises a 90 degree angle.

4. An integrated food containment and placement apparatus as described in claim 3 wherein each said inside corner comprises a 90 degree angle.

5. (canceled)

6. An integrated food containment and placement apparatus as described in claim 1 wherein said inside corner having a compound double-cut configuration comprises an inside corner having a double-cut configuration, wherein one cut of said double-cut configuration comprises a 90 degree angle and a 45 degree angle.

7. (canceled)

8. An integrated food containment and placement apparatus as described in claim 1 wherein at least one said inside corner comprises an angle of less than 90 degrees.

9-19. (canceled)

20. An integrated food containment and placement apparatus as described in claim 1 further comprising a layered structure of said foldable food item containment pouch, wherein said layered structure of said foldable food item containment pouch comprises at least two contiguous layers, each said contiguous layer in stacked alignment and having a shape substantially in correspondence with all other contiguous layers, and each said contiguous layer attached to all adjoining contiguous layers, and wherein each said contiguous layer attached to all adjoining contiguous layers comprises said contiguous layer attached to the adjoining contiguous layers along aligned peripheral edges thereof.

21. An integrated food containment and placement apparatus as described in claim 1 further comprising a layered structure of said foldable food item containment pouch, wherein said layered structure of said foldable food item containment pouch comprises at least two contiguous layers, each said contiguous layer in stacked alignment and having a shape substantially in correspondence with all other contiguous layers, and each said contiguous layer attached to all adjoining contiguous layers, and wherein each said contiguous layer attached to all adjoining contiguous layers comprises said contiguous layer laminated to the adjoining contiguous layers.

22. A method of converting a food placement mat into a food storage container comprising the steps of:
folding over a first fold panel of a foldable food item containment pouch along a first fold axis of said foldable food item containment pouch;
moving an edge of said first fold panel from an inside corner position to an outside corner position, wherein said edge of said first fold panel corresponds to at least one cut of an adjacent inside corner to said first fold panel having at least a double-cut configuration;
folding over a second fold panel of said foldable food item containment pouch along a second fold axis of said foldable food item containment pouch;
moving an edge of said second fold panel from an inside corner position to an outside corner position, wherein said edge of said second fold panel corresponds to at least one cut of an adjacent inside corner to said second fold panel having at least a double-cut configuration;
forming a folded outside corner of said foldable food item containment pouch replacing said inside corner of said foldable food item containment pouch, said folded outside corner having at least some overlapping portions of a left adjacent fold panel and a right adjacent fold panel of said foldable food item containment pouch, said folded outside corner forming an interior food placement surface of said foldable food item containment pouch within said fold, and said folded outside corner forming an exterior food protection surface of said foldable food item containment pouch outside of said fold;
and:
wherein said step of moving an edge of said first fold panel from an inside corner position to an outside corner position comprises the step of moving a left edge and a right edge of said first fold panel from an inside corner position to an outside corner position, wherein said left edge of said first fold panel corresponds to at least one cut of a left adjacent inside corner to said first fold panel having at least a double-cut configuration, and wherein said right edge of said first fold panel corresponds to at least one cut of a right adjacent inside corner to said first fold panel having at least a double-cut configuration;
wherein said step of moving an edge of said second fold panel from an inside corner position to an outside corner position comprises the step of moving a left edge and a right edge of said second fold panel from an inside corner position to an outside corner position, wherein said left edge of said second fold panel corresponds to at least one cut of a left adjacent inside corner to said second fold panel having at least a double-cut configuration, and wherein said right edge of said second fold panel corresponds to at least one cut of a right adjacent inside corner to said second fold panel having at least a double-cut configuration;
and further comprising the steps of:
folding over a third fold panel of said foldable food item containment pouch along a third fold axis of said foldable food item containment pouch;
moving a left edge and a right edge of said third fold panel from an inside corner position to an outside corner position, wherein said left edge of said third fold panel corresponds to at least one cut of a left adjacent inside corner to said third fold panel having at least a double-cut configuration, and wherein said right edge of said third fold panel corresponds to at least one cut of a right adjacent inside corner to said third fold panel having at least a double-cut configuration;
folding over a fourth fold panel of said foldable food item containment pouch along a fourth fold axis of said foldable food item containment pouch;
moving a left edge and a right edge of said fourth fold panel from an inside corner position to an outside corner position, wherein said left edge of said fourth fold panel corresponds to at least one cut of a left adjacent inside corner to said fourth fold panel having at least double-cut configuration, and wherein said right edge of said fourth fold panel corresponds to at least one cut of a right adjacent inside corner to said fourth fold panel having at least a double-cut configuration;
and:
wherein said step of forming a folded outside corner comprises the step of forming a number of folded outside corners of said foldable food item containment pouch replacing said inside corners of said foldable food item containment pouch, each said folded outside corner having at least some overlapping portions of a left adjacent fold panel and a right adjacent fold panel of said foldable food item containment pouch, said folded outside corners forming an interior food placement surface of said foldable food item containment pouch within said folds, and said folded outside corners forming an exterior food protection surface of said foldable food item containment pouch outside of said folds:
and further comprising the step of sealing at least one said folded outside corner, wherein said step of sealing comprises the step of sealing at least one said folded outside corner with a wing, and wherein said step of sealing comprises a step selected from the group consisting of sealing with a wing joined to each edge of an inside corner having a double-cut configuration at about 0.5 inches from said inside corner, sealing with a wing joined to each edge of an inside corner having a double-cut configuration at about 1.0 inch from said inside corner, sealing with a wing joined to each edge of an inside corner having a double-cut configuration at about 1.5 inches from said inside corner, sealing with a wing joined to each edge of an inside corner having a double-cut configuration at about 2.0 inches from said inside corner, sealing with a wing joined to each edge of an inside corner having a double-cut configuration at about 2.5 inches from said inside corner, and sealing with a wing joined to each edge of an inside corner having a double-cut configuration at about 3.0 inches from said inside corner.

23. (canceled)

24. A method of converting a food placement mat into a food storage container as described in claim 22, wherein at least one said step of folding over a fold panel comprises the step of folding over said fold panel oriented at a 90 degree angle relative to at least one other said fold panel.

25. A method of converting a food placement mat into a food storage container as described in claim 24, wherein each said step of folding over a fold panel comprises the step of folding over said fold panel oriented at a 90 degree angle relative to at least one other said fold panel.

26. (canceled)

27. A method of converting a food placement mat into a food storage container as described in claim 22, wherein at least one said step of moving an edge of a fold panel comprises the step of moving said edge of said fold panel, wherein said edge corresponds to at least one cut of an adjacent inside corner having a compound double-cut configuration, and wherein said step of moving said edge of said fold panel further comprises the step of moving said edge of said fold panel, wherein said edge corresponds to at least one cut of an adjacent inside corner having a 90 degree angle and a 45 degree angle.

28. (canceled)

29. A method of converting a food placement mat into a food storage container as described in claim 22, wherein at least one said step of folding over a fold panel comprises the step of folding over said fold panel oriented at an angle of less than 90 degrees relative to at least one other said fold panel.

30-37. (canceled)

38. A method of converting a food placement mat into a food storage container as described in claim 22, further comprising the step of creating a layered structure of a foldable food item containment pouch, wherein said step of creating a layered structure of a foldable food item containment pouch comprises a step selected from the group consisting of: creating at least one layer comprising cloth; creating at least two layers comprising cloth; creating at least three layers comprising cloth; creating at least one layer comprising plastic; creating at least two layers comprising plastic; creating at least three layers comprising plastic; creating at least one layer comprising a material that is not plastic or cloth; creating at least two layers comprising a material that is not plastic or cloth; and creating at least three layers comprising a material that is not plastic or cloth; and wherein said plastic comprises plastic selected from the group consisting of: vinyl; vinyl coated fabric; LDPE; nylon; polypropylene; and plastic having a thickness of about 3 mm.

39. A method of converting a food placement mat into a food storage container as described in claim 22, further comprising the step of creating a layered structure of a foldable food item containment pouch, wherein said step of creating a layered structure of a foldable food item containment pouch comprises a step selected from the group consisting of: creating at least one layer comprising cloth; creating at least two layers comprising cloth; creating at least three layers comprising cloth; creating at least one layer comprising plastic; creating at least two layers comprising plastic; creating at least three layers comprising plastic; creating at least one layer comprising a material that is not plastic or cloth; creating at least two layers comprising a material that is not plastic or cloth; and creating at least three layers comprising a material that is not plastic or cloth; and wherein said cloth comprises cloth selected from the group consisting of: cotton; polyester; or a blended cloth.

40. (canceled)

41. A method of converting a food placement mat into a food storage container as described in claim 22, further comprising the step of creating a layered structure of a foldable food item containment pouch, wherein said step of creating a layered structure of a foldable food item containment pouch comprises the step of shaping at least two layers substantially in correspondence with one another, stacking said layers in contiguous alignment with one another, and attaching said layers adjacent to one another, wherein said step of attaching said layers adjacent to one another comprises the step of attaching said layers along aligned peripheral edges thereof.

42. A method of converting a food placement mat into a food storage container as described in claim 22, further comprising the step of creating a layered structure of a foldable food item containment pouch, wherein said step of creating a layered structure of a foldable food item containment pouch comprises the step of shaping at least two layers substantially in correspondence with one another, stacking said layers in contiguous alignment with one another, and attaching said layers adjacent to one another, wherein said step of attaching said layers adjacent to one another comprises the step of laminating said layers together.

43-84. (canceled)

85. An apparatus as described in claim 1, further comprising a food item placed on said interior food placement surface of said foldable food item containment pouch, wherein said food item comprises a sandwich.

86-90. (canceled)

91. An apparatus as described in claim 1, wherein said at least one volume adjustable fold comprises at least one fold panel of said foldable food item containment pouch.

92-102. (canceled)

103. An apparatus as described in claim 1, further comprising a corner seal situated at at least one said inside corner, wherein said corner seal comprises a wing, wherein said wing comprises a wing selected from the group consisting of a wing joined to each edge of an inside corner having a double cut configuration at about 0.5 inches from said inside corner, a wing joined to each edge of an inside corner having a double cut configuration at about 1 inch from said inside corner, a wing joined to each edge of an inside corner having a double cut configuration at about 1.5 inches from said inside corner, a wing joined to each edge of an inside corner having a double cut configuration at about 2.0 inches from said inside corner, a wing joined to each edge of an inside corner having a double cut configuration at about 2.5 inches from said inside corner, and a wing joined to each edge of an inside corner having a double cut configuration at about 3.0 inches from said inside corner.

104. An apparatus as described in claim 1, further comprising a corner seal situated at at least one said inside corner, wherein said corner seal comprises a wing, wherein said wing comprises a wing selected from the group consisting of a wing covering about 5% of the area of a material-free fold zone, a wing covering about 10% of the area of a material-free fold zone, a wing covering about 15% of the area of a material-free fold zone, a wing covering about 20% of the area of a material-free fold zone, a wing covering about 25% of the area of a material-free fold zone, a wing covering about 30% of the area of a material-free fold zone, a wing covering about 35% of the area of a material-free fold zone, a wing covering about 40% of the area of a material-free fold zone, a wing covering about 45% of the area of a material-free fold zone, and a wing covering about 50% of the area of a material-free fold zone.

105-114. (canceled)

115. A method as described in claim 22 further comprising the step of containing a food item within said interior food placement surface of said foldable food item containment pouch, wherein said food item comprises a sandwich.

116-133. (canceled)

134. A method as described in claim 22 further comprising the step of sealing at least one said folded outside corner, wherein said step of sealing comprises the step of sealing at least one said folded outside corner with a wing, wherein said step of sealing comprises a step selected from the group consisting of covering about 5% of the area of a material-free fold zone with said wing, covering about 10% of the area of a material-free fold zone with said wing, covering about 15% of the area of a material-free fold zone with said wing, covering about 20% of the area of a material-free fold zone with said wing, covering about 25% of the area of a material-free fold zone with said wing, covering about 30% of the area of a material-free fold zone with said wing, covering about 35% of the area of a material-free fold zone with said wing, covering about 40% of the area of a material-free fold zone with said wing, covering about 45% of the area of a material-free fold zone with said wing, and covering about 50% of the area of a material-free fold zone with said wing.

135-140. (canceled)
